(19) United States
(12) Patent Application Publication
(10) Pub. No.: US 2020/0117835 A1
(43) Pub. Date: Apr. 16, 2020

(54) METHOD FOR HANDWRITTEN ELECTRONIC SIGNATURE

(71) Applicant: MATTHIAS OLSCHOWY, BERGISCH GLADBACH (DE)

(72) Inventor: MATTHIAS OLSCHOWY, BERGISCH GLADBACH (DE)

(21) Appl. No.: 16/612,115

(22) PCT Filed: May 3, 2018
(86) PCT No.: PCT/EP2018/061258

§ 371 Date: Nov. 8, 2019

(30) Foreign Application Priority Data
May 10, 2017 (DE) 10 2017 110 048.2

(51) Int. Cl. G06F 21/64; G06F 21/32; G06K 9/00

(52) U.S. Cl. CPC G06F 21/64; G06K 9/00187; G06F 21/32

(57) ABSTRACT

A method for the electronic signature of an electronic document (DOC) by means of a handwritten signature, wherein detection means (EM) detect the handwritten signature and at least one biometric feature characterizing the handwritten signature electronically. A characterizing means (KM1, KM2, KM3) generates a character sequence (HED, HES1, HES2) characterizing the electronic document (DOC). An output means (AM1, AM2) exposes the characterizing character sequence (HED, HES1, HES2) for the signer for the handwritten copying. The detection means (EM) electronically detects a character sequence (SBH) copied in handwriting and at least one biometric feature (BMH) characterizing the character sequence (SBH) copied in handwriting. An electronic signature means (SM) generates an electronic data record (SIG) at least based on the characterizing character sequence (HED, HES1, HES2) and at least one biometric feature (BMH) characterizing the character sequence copied in handwriting (SBH). Furthermore, the invention comprises a signature generating system for application of the method according to the invention and a unit for a signature generating system according to the invention.

### CROSS-REFERENCE TO RELATED APPLICATIONS

This application is a 35 U.S.C. § 371 national phase of PCT International Application No. PCT/EP2018/061258, filed May 3, 2018, which claims the benefit of priority under 35 U.S.C. § 119 to German Patent Application No. 10 2017 110 048.2, filed May 10, 2017, the contents of which are incorporated herein by reference in their entirety.

### FIELD OF THE INVENTION

The invention relates to a method for a handwritten electronic signature (HES) of an electronic document by means of a handwritten signature, wherein detection means electronically detect the handwritten signature and at least one biometric feature characterizing the handwritten signature, wherein at least one characterizing means produces a character sequence characterizing the electronic document, and wherein an electronic signature means produces an electronic signature record for the electronic document at least based on the character sequence characterizing the electronic document. In addition, the invention relates to a signature generation system for applying the method, having at least one first document memory in which an electronic document can be stored, at least one first display means by means of which the electronic document can be displayed, at least one electronic detector means by means of which a handwritten signature, together with at least one biometric feature characterizing the handwritten signature, can be electronically detected, at least one characterizing means by means of which a character sequence characterizing the electronic document can be produced, and an electronic signature means by means of which an electronic signature record for the electronic document can be produced at least based on the character sequence characterizing the electronic document, wherein at least the first electronic characterizing means produces a first character sequence characterizing the electronic document from data of the electronic document in the first document memory.

### BACKGROUND

By means of an electronic signature or handwritten signature, the signing person conclusively declares their wish and their agreement with the content of the document signed in each case. So that a concrete signature is actually conclusive, it should unambiguously authenticate the signing person, i.e. it should be proof that a particular person, and no-one else, has expressed their wish and it should be unambiguously joined to the document to be signed, i.e. a connection between it and another document should be impossible.

An advantageous security principle in electronic signature methods consists in safeguarding the signature method against attacks by a number of mutually independent protective measures. Apart from the security, practicability is expected from a signature method so that the expenditure associated with each signature and the total expenditure are as low as possible. Both requirements, that for security and that for practicability compete with one another.

The method of the handwritten signature on paper can be considered to be secure in those cases in which the receiver of the signature or a representative is witness to the signing. Otherwise, however, the receiver of the signature only has the possibility of checking visually in as much he knows the handwritten signature of the signing person at all. If the handwritten signature is unknown to him, he is completely dependent on trust if he does not wish to expend considerable expenditure for checking it. In comparison with a handwritten electronic signature (HES) it is disadvantageous that only the written face is available even for a thorough check but not, in contrast, the important biometric features created in the context of the HES. A further problem is the widely used practice, sacrificed to practicability, of signing multi-page documents only on one page, such that subsequent document forgeries are not impossible. A problem, becoming more and more urgent, is the practicability of the handwritten signature which is correspondingly decreasing due to the increasing digitization since signatures created in this manner are produced outside the digital domain and naturally will also remain such, in any case as original. Finally, a problem should be pointed out that initially appears only to be one of the handwritten electronic signature (HES), namely, as also mentioned later on, the software-implemented simulation of a forged signature. The handwritten signature on paper is affected by this technical development in the same way, however, since a robot appropriately equipped with software can then sign the forged signature on paper.

The known qualified electronic signature (QES) uses, in particular, a PKI certificate. Depending on the context of the use of the term, PKI certificate is to be understood here for this application, in the narrower sense, as the data record, e.g. in the format of the X.509 standard, which, in particular, contains the public key of an asymmetric public key pair and further information relating to the certification point and relating to the certificate owner and in the wider sense as the pair which consists of the certificate in the narrower sense and the secrete key matching the public key.

The known QES and the associated method have, in particular, the following disadvantages:

Firstly, the security of the QES is based completely on the secret key being kept secret. Attacks against it are possible during the creation of the pair of keys and/or by a method which is still able to read out the memory in which the secret key is deposited although it can for all intents and purposes not be read out.

Secondly, an attack on the six-digit PIN is possible by means of which the misuse of the signature card which contains the secret key (in the non-readable memory) and in addition the certificate with the public key is secured.

Thirdly, an extension of the problem surround the secret key consists in that it can only be excluded organizationally and with great care but not in principle that PKI certificates are generated also without the agreement and the knowledge of the persons, organizations, undertakings or authorities affected. By the time of forgery has been detected, considerable damage can already have been caused.

Fourthly, it must be noted in this context that a forged QES signature does not itself have any kind of information available which would allow the signer to contradict the alleged authenticity. Instead, the duty of proof is unrestrictedly that of the signer to prove that one of the abovementioned attacks has taken place without his involvement. The revocation of a signature thus has to have the complexity of a criminal case in that, since from a signature itself no evidence can be obtained which speaks for or against the authenticity, the comparatively unlimited environment of the persons and organizations involved has to be examined. The handwritten signature, in contrast, provides the possibility of checking the authenticity of the signature by focusing on the latter itself with the aid of a handwriting expert.

Fifthly, the method of the QES, like that of the so-called advanced electronic signature, consists in that from the document to be signed a hash value is calculated in a first step and the latter is encrypted with the secret key of the signer in a second step. The QES is characterized by the fact, among other things, that the calculation of the hash value takes place in a signature generating unit (for example chip card reader) which is different from the document unit (for example personal computer) in which the document is actually stored, and is also not a part of it and, therefore, represents an external unit from the perspective of this document unit. To perform the QES, both units are bidirectionally connected to one another and the document or a hash value based on the document is transferred from the document unit to the signature generating unit and after production of the signature the latter is transferred again from the signature generating unit to the document unit. The core of the essence of the signature is the encryption, i.e. the already mentioned second step. The hash value itself is a short version of the document generated by cryptographic means without reference to the signer which is generated only by the encryption with the secret key of the signer. In fact, therefore, instead of the document itself, its short version is signed. A problem of the method in this context may now consist in that both steps, the calculation of the hash value and the encryption thereof, are performed in the document unit or the signature generating unit without interruption which would provide the signer with the possibility of convincing himself of the correctness of the calculated hash value before signing it. Thus, it is not impossible that he signs the hash value of another document which is possible in principle if the document unit is compromised and supplies the signature generating unit with another document or another hash value than is actually intended by the signer. It is basically not even impossible that the signature generating unit itself is compromised.

DE 10 2011 050 156 B4 describes a known method for handwritten electronic signature (HES) of an electronic document by means of a handwritten signature. The method is based on a first apparatus by means of which a person provides a handwritten signature and by means of which the characteristic signature data of the signature of the person are captured. The first apparatus also receives from a second apparatus document data representing the document to be signed, and electronically combines the document data with the signature data to produce combination information. Subsequently, the first apparatus electronically signs the combination information by means of an asymmetric key pair (such as for example using a qualified electronic signature) and transmits the signed combination information to the second apparatus. The second apparatus connects the document to the signed combination information and extracts the signature data from the combination information and outputs them for checking by the person. For this method, it is assumed that at least the integrity of the first apparatus and of the secret key of the asymmetric key pair used for signing is sound. This cannot normally be checked for the person who is to sign, however. If the first apparatus is compromised, it is possible in particular for the digitally detected signature to be tapped off, copied and/or used for signing other documents or other hash values without the knowledge of the signing person. Even with an uncompromised unit, the security of the encryption is not absolute and can fundamentally be decrypted using suitable technical means in sufficient time, depending on the algorithm used and the key length.

The HES is basically known, for example, using electronic signature pads as a signature generating unit. In this context, the signer signs by means of the signature generating unit with his handwritten signature on a pressure-sensitive sensor surface wherein, in particular, the signature is detected digitally by its face.

In distinction from the handwritten signature on paper, the HES can record, beyond the face of the handwritten signature, further features of the handwritten signature which are called biometric features although of course the face itself is also a biometric feature. In the case of a signature pad, the recording of the physical trace described by the point of the pen together with the variation of pressure in the point of pen with time and on the writing base provides the full extent. The trace is recorded best in relation to a Cartesian (x, y) coordinate system and thus comprises the motion in time in an x direction and in a y direction, that is to say the two functions x and y in dependence on time t:

t→x(t)

t→y(t)

To this is added, as already mentioned, the variation of pressure with time:

t→d(t)

The face can be derived from the trace, that is to say the two functions x(t) and y(t) so that the biometric features do not contain additional information but, as mentioned, the full extent of information of the handwritten signature.

The basic problem of the known HES is that it can be copied and thus be misused again for the connection with another electronic document, in contradiction to the demand for uniqueness of the connection.

The problem consists more precisely in that the HES is not intrinsically connected to the document to be signed, but is produced in the signature generating unit initially, independently, of the document and is connected to the document only in a second step, at best inside the signature generating unit; compare above-mentioned patent DE 10 2011 050 156 B4 or else EP 2 367 128 A1. For testing purposes, however, it is necessary to be able to expose the handwritten signature again completely including its biometric features so that the connecting process also needs to be reversible. These problems have the effect, among other things, that the biometric features are at least partially encrypted in order to release them again by decryption only when needed for a test. In this context, the encryption is performed, e.g. with the public key of an asymmetric pair of keys of which the secret counterpart is securely stored, e.g. with a notary. If necessary, the encrypted data can be decrypted with cooperation of the notary. However, the encryption of biometric features of the handwritten signature has the following problems:

It must be ensured that all signature generating units of all manufacturers worldwide securely encrypt the biometric features of the handwritten signature, specifically for all signatures produced in the past, present and future. Otherwise, it could be, for instance, that handwritten electronic signatures with their biometric features are traded, e.g. on the black market. A single copy released and obtained by the wrong hands is sufficient for being used in an attack.

For the receiver of the signature, encrypted biometric features are associated either with additional expenditure with respect to a signature check, namely e.g. using the support by the notary's office which cannot always be provided, or he is satisfied with an HES which has been checked only insufficiently. Although a thorough test of the HES by the receiver of the signature is not always necessary, e.g. not when the recording takes place in the presence of the receiver of the signature himself or his representative and he provides the signature generating unit used himself at the same time. The possibility of a test must not be obstructed by basic administrative, organizational or psychic obstacles, however.

In comparison with the QES, the known methods of the HES also have the problem that the signature method does not open the possibility of performing uncomplicated checks of the HES for authenticity which are not only based on the visual appearance of the handwritten signature face in so far as the face, at least, is known to the receiver of the signature. Instead, the signer should be in possession of a trustworthy sample of writing which also comprises the biometric features.

A further problem is added for the HES in so far as the signature generating unit is configured to record biometric features, that these can be modified or even be completely unusable during their creation. This can be due to a hardware or software fault in the signature generating unit or also due to the fact that in spite of the comparatively simple and protected environment of the signature generating unit, the latter is compromised due to an attack. Signatures generated in this way could be contestable by the signer in the case of a dispute. The problem is acute when the biometric data are only checked in the case of a dispute or considered or used at all and the condition may therefore even remain unnoticed over a relatively long period.

EP 2 350 911 B1 describes a simple handwritten signature that is electronically detected for a document and stored together with the document. The calculated hash value of the document is displayed to the user in this case and is used by the signing user to check whether the correct document has been transmitted from the computer to the signature detection device, and for cryptographic use by the computer and by the signature detection device. If a secure and uncompromised signature detection device can be assumed, the signer can satisfy himself of the correctness of the calculated hash value used before he signs the document or the hash value representing the document. There is still in particular the disadvantage described above that the digitally detected handwritten signature could be copied and used for other documents.

US 2008/177799 A1 describes, in connection with an integrity check on a printed document, the generation of a hash-value-like integrity check code for a document. The integrity check code can be written on the document. This integrity check code is used not for forming a signature, however, but rather just for possibly detecting a modification to the document content.

The invention is based on the object of providing a method for a handwritten electronic signature (HES) and a signature generating system for such a method which improves the problems described above and, in particular, guarantees the reliability of the uniqueness of the person and of the uniqueness of the connection with a document and, in doing so, simplifies its testability.

According to the invention, the object is achieved by a method by a signature generating system having the features described and claimed herein.

### SUMMARY

In the method according to the invention, an output means visually or acoustically exposes the character sequence characterizing the electronic document and/or a short form based thereon for the signer for handwritten copying. Subsequently, the detection means electronically detects a character sequence copied from the characterizing character sequence in handwriting and at least one biometric feature characterizing the character sequence copied in handwriting. After that, the electronic signature means generates an electronic signature record for the electronic document at least based on the character sequence (SBH) copied from the characterizing character sequence (HED, HES1, HES2) in handwriting and/or the biometric feature characterizing the character sequence copied in handwriting.

The signature generating system according to the invention outputs, by means of at least one first output means electronically connected to the first characterizing means, the first characterizing character sequence and/or a short form based thereon visually or acoustically. Subsequently, the detection means electronically detects at least the character sequence copied from the characterizing character sequence in handwriting together with at least one biometric feature characterizing the character sequence copied in handwriting. After that, an electronic signature means generates an electronic signature record for the electronic document at least based on the character sequence (SBH) copied from the characterizing character sequence (HED, HES1, HES2) in handwriting and/or the biometric feature characterizing the character sequence copied in handwriting.

### BRIEF DESCRIPTION OF THE DRAWINGS

Such a method and signature generating system has the advantage that an HES is provided for which prevents a misuse by the re-use of a copy of the handwritten signature since each individual handwritten signature is unambiguously designed for a quite particular document.

Further advantageous embodiments of the invention are obtained from the subsequent description of the figures. In which:

FIG. 1A shows an exemplary coding table for use in a characterizing means according to the invention,

FIG. 1B shows a conversion of an exemplary hash value according to the coding table from FIG. 1A,

FIG. 2A shows a block diagram of a first embodiment of a signature generating system according to the invention,

FIG. 2B shows a block diagram of a second embodiment of a signature generating system according to the invention,

FIG. 2C shows a block diagram of a third embodiment of a signature generating system according to the invention.

### DETAILED DESCRIPTION

In the various figures of the drawing, identical parts are always provided with the same reference symbols.

With respect to the subsequent description, it is claimed that the invention is not restricted to the illustrative embodiments and in this context is not restricted to all or several features of described components of features; instead, each individual part of a feature of the/each illustrative embodiment is of significance to the subject matter of the invention also detached from all other part-features described in connection therewith by itself but also in combination with any features of another illustrative embodiment.

A core concept of the method according to the invention and of the signature generating system according to the invention is that it is not the name signature usually provided, that is to say the handwritten drawing of the name, which is of significance for an authentication of the signer, but his handwriting.

To exaggerate slightly, a possibility would consist in that the signer copies the complete document in handwriting. Since, as a rule, this cannot be expected either from the signer or by the receiver of the signature, a, practically, reversibly unambiguous short version of the electronic document is used for the method according to the invention in the form of a character sequence HED, HES1, HES2 characterizing the document DOC or, respectively, an abbreviated short form HEDₖ, HES1ₖ, HES2ₖ of the characterizing character sequence HED, HES1, HES2 based thereon is used which must be copied in handwriting by the signer. For this purpose, according to the invention, a characterizing means KM1, KM2, KM3 generates the characterizing character sequence, HED, HES1, HES2 characterizing the electronic document DOC.

Such a characterizing character sequence HED, HES1, HES2 is preferably a hash value H of the document which is generated by means of a characterizing means KM1, KM2, KM3. The hash value H is specified especially as hexadecimal value, e.g. based on an SHA-256 hash algorithm as a 256-bit hexadecimal character sequence:
H=C1 42 B0 F7 93 5A A3 60 19 D7 38 3E B5 12 53 FE
2B 6F DE 0D 7E 70 D3 8A 19 11 37 5F 08 2B AB 93

In this context, it is particularly advantageous if the characterizing means KM1, KM2, KM3 calculates the characterizing character sequence HED, HES1, HES2 as a hash value H of the electronic document DOC in a representation which is based on a character set ZS which, differently from the hexadecimal digits, provides for handwritten writing of coherent character chains, that is to say words. The handwritten writing of words is necessary because the handwritten writing of isolated characters, in turn, opens up the possibility of copying these isolated characters from which the characterizing character sequence of other documents can be formed by being joined together.

The hexadecimal numbers are usually not written in coherent words or characters connected to one another in handwriting, the Arabic numbers 0 to 9 even exclusively isolated and the capital letters A to F only at the start of words, which is why, on the one hand, both are unsuitable for forming handwritten words. On the other hand, hexadecimal numbers have the decisive advantage that they precisely code the values of a half byte for which purpose after all the hexadecimal set of characters was created at all.

If the size of a character set ZS which is suitable for forming words is a power of two 2ⁿ, the character set ZS can be used for coding a bit sequence of length n analogously to the hexadecimal character set.

In particular, the characterizing means KM1, KM2, KM3, for generating the characterizing character sequence HED, HES1, HES2 calculates a hash value H from data of the electronic document DOC and subsequently converts the characters of the hash value H into a character representation which is based on a character set ZS which comprises more than sixteen characters. The characterizing means KM1, KM2, KM3 preferably uses for generating the characterizing character sequence HED, HES1, HES2 a character set ZS, which consists of 26 small letters of the modern Latin alphabet. Alternatively, a similarly large amount of any other characters of other languages or cultures is also possible in this case.

It is true that the character set ZS could be brought to the size of a power of two by reducing its size. The disadvantage of this is, however, that a larger character set, apart from possible disadvantages, has the one safe advantage of greater variety and thus that of greater complexity of the character sequences to be copied. If in the extreme case the character set were to consist, for instance, only of the binary numbers 0 and 1 as characters, the resultant complexity of the drawing of the character sequence to be copied for a signature would be definitely too small. There can thus be an interest in not reducing a possible character set in size, certainly if the character set is already rather small in any case. In the context of the invention, small means a maximum of sixteen characters. Conversely, it will therefore be necessary to enlarge the character set or from the existing one to construct a new and larger one with the size of a power of 2ⁿ which can be done in the following manner:

The characters of the character set ZS are combined to form supercharacters, i.e. either to form pairs or to form triples or to form quadruples or larger combinations which corresponds to a subset of the m-fold Cartesian product of the character set ZS understood to be a set, m being equal to 2 in the case of pairs and equal to 3 in the case of triples. The number m is selected to be at least such a size that at least 2ⁿ supercharacters can be formed and thus the coding of each value of a bit sequence BS of length n is possible with one supercharacter. Quadruples would be suitable for forming supercharacters of length four from characters of the alphabet of a natural language in order to code with these bit sequences of length sixteen having a range of values of 2¹⁶=65 536. Thus, for instance in the case of the German language, the supercharacters quad, adru and rupe could be formed from the word Quadrupel, among others. It would not even have to be parts of real words of the respective language. Advantageously, however, the supercharacters are formed in harmony with the natural feeling of language so that the writing of each supercharacter, as coherent character chain, is correspondingly easier. In the case of character pairs, that is to say m=2, a method suitable for the entire Western world which is language-independent, and therefore dispenses with the formation of character sequences felt to be natural, is presented below.

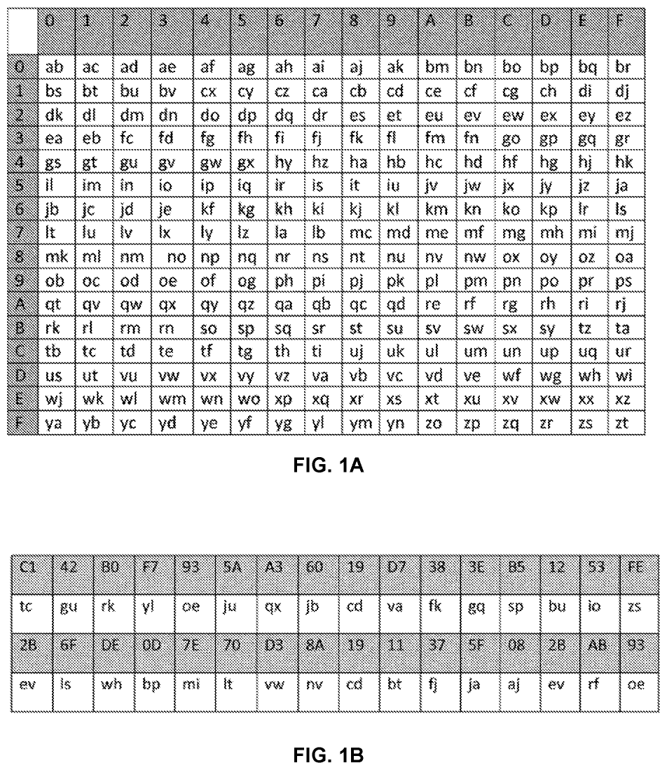

An exemplary coding table for a coding BS-K of a characterization means KM1, KM2, KM3 for converting the hash value H is shown in FIG. 1A. In the advantageous embodiment, the characterizing means KM1, KM2, KM3 in each case converts values of an 8-bit sequence of the hash value H into a supercharacter in the form of a character pair of the character set ZS. FIG. 1B shows the exemplary conversion of the exemplary hash value H from the top by a characterizing means KM1, KM2, KM3 by means of the coding table according to FIG. 1A.

In order to improve the security of the written characterizing character sequence HED, HES1, HES2, i.e. in order to prevent that new signatures can be assembled from the parts of many signatures already made in the past, and thus can be forged, it is advantageous that the output means AM1, AM2 combines at least two, particularly three of the supercharacters following one another in each case, or pairs of characters, respectively, to form in each case one combined word of the characterizing character sequence HED, HES1, HES2. Thus, the exemplary characterizing character sequence HED, HES1, HES2 is obtained, for example for the exemplary hash value H from above and the converted supercharacters or pairs of characters according to FIG. 1B:
tcgu rkyl oeju qxjb cdva fkgq spbu iozs
evls whbp milt vwnv cdbt fjja ajev rfoe

Advantageously, the characterizing character sequence HED, HES1, HES2 is converted by the characterizing means KM1, KM2, KM3 further by means of a permutation of the individual characters of the supercharacters or the pairs of characters so that the occurrence of a character at a place of the characterizing character sequence HED, HES1, HES2 is in each case independent at least of its directly adjacent characters in order to thus maximize the variety of combinations of adjacent characters. This can be achieved, for example, in that first the characters at an odd position of the characterizing character sequence HED, HES1, HES2 are chained together behind one another and then the characters at an even position of the characterizing character sequence HED, HES1, HES2 are chained together behind one another. This will lead to the following representation of the then rearranged hash value H according to the above example:
tgry ojqj cvfg sbiz elwb mlvn cbfj aero
cukl euxb dakq puos vshp itwv dtja jvfe

With these various conversions, the first thirty-two characters are all completely independent of one another.

In an advantageous embodiment, the output means AM1, AM2 exposes at least only the first sixteen characters, particularly only the first twenty-four characters of the characterizing character sequence HED, HES1, HES2 as short form HEDₖ, HES1ₖ, HES2ₖ of the characterizing character sequence HED, HES1, HES2 for the signer for handwritten copying. This can be done in the form of a special emphasis in the representation of the entire characterizing character sequence HED, HES1, HES2 itself, for example by underlying or emboldening or by a separate representation of the short form HEDₖ, HES1ₖ, HES2ₖ. This results for the exposed short form HEDₖ, HES1ₖ, HES2ₖ, according to the above example of the hash value H, for example in:
tgry ojcj cvfg sbiz

For the exemplary choice of the first four words having a total length of sixteen letters for the short form HEDₖ, HES1ₖ, HES2ₖ, there is a number of 26¹⁶ different such short forms of the characterizing character sequences HED, HES1, HES2, which is slightly greater than 2⁷⁵. The restriction to the sixteen characters in the short form HEDₖ, HES1ₖ, HES2ₖ thus corresponds to a 75-bit hash. With six words having four characters each or also four words having six characters each, a number corresponding to a 112-bit hash is obtained.

For each of the words having four characters, there are 26⁴=456 976 possible character combinations so that with only four characters, the probability of a repetition of only one of the words to be drawn is already low. With six-character words, there are 26⁶=308 915 776 different words.

This method with the formation of supercharacters in the form of character pairs, presented here, with the subsequent permutation described by way of example, has as an advantage compared with the method described further above which uses supercharacters with natural-language quadruples, that the number of 456 976 of the words formed here, having in each case four characters, is considerably larger than the number of 65 536 quadruples in that case and thus their probability for a repetition with different electronic documents is correspondingly smaller.

How long the short form HEDₖ, HES1ₖ, HES2ₖ of the characterizing character sequence HED, HES1, HES2 advantageously is depends on the requirement for the security of the HES. The security increases both with the length of the drawn words and with the length of the short form HEDₖ, HES1ₖ, HES2ₖ of the characterizing character sequence HED, HES1, HES2. The disadvantage of long words is that their handwritten copying may be difficult because of their lack of familiarity. The disadvantage of many characters overall can also make the signing appear to be difficult so that the method loses acceptance overall.

Furthermore preferably, the characters used can be extended in a simple manner by the capital letters, with unchanged handwritten writability of the characterizing character sequence HED, HES1, HES2, in that the characterizing means KM1, KM2, KM3 converts the first character of a composite word of the characterizing character sequence HED, HES1, HES2 into the capital letter corresponding to the small letter. Thus, for example, the exemplary hash value H from the top and the converted supercharacters or character pairs, respectively, according to FIG. 1B produce the exemplary short form HEDₖ:
Tgry Ojqj Cvfg Sbiz

According to the invention, the characterizing character sequence HED, HES1, HES2 and/or the short form HEDₖ, HES1ₖ, HES2ₖ is exposed by an output means AM1, AM2 for the signer for handwritten copying. Subsequently, according to the invention, a detection means EM detects a character sequence SBH copied in handwriting which corresponds to a handwritten copy of the characterizing character sequence HED, HES1, HES2 and/or the short form HEDₖ, HES1ₖ, HES2ₖ. In this context, the detection means EM detects at least one biometric feature BMH, characterizing the character sequence SBH copied in handwriting.

Additionally to the character sequence SBH copied in handwriting, the particular signature by name SBU will preferably also be detected together with at least one biometric feature BMU characterizing the particular signature by name SBU.

According to the invention, an electronic signature record SIG is generated which is based at least on the first characterizing character sequence HED, HES1, HES2 and at least on the biometric feature BMH characterizing the character sequence SBH copied in handwriting.

The HES according to the invention, in the form of the signature record SIG provides a great measure of security even in an insecure environment as long as the characterizing character sequence HED of the document DOC is calculated securely. The simple copying of the HES according to the invention is unproblematic since it would not be usable for other documents than the document DOC or would be invalid in this case.

In order to further improve the forgery protection and impair the collecting of many different HES according to the invention of a person and the use of these for an artificial or simulated assembly of signature segments to form a valid HES for another document, it is provided in a further embodiment of the invention that, in particular, the biometric features BMH of the character sequence SBH copied in handwriting are encrypted with at least one public key PK of an asymmetric pair of keys cryptographically to form an encrypted biometric feature BMH. In addition, the biometric features BMU of the particular signature by name SBU can also be encrypted with the key PK to form an encrypted biometric feature BMUᵥ. This prevents that a third party who has collected various HES of a person can evaluate the biometric features of part-segments of the signature and use them for an artificial generation of a new HES for another document.

The public key PK is allocated, in particular, to the signer or a certification office and preferably configurable. In particular, a public key PK can also be selectable for the encryption from a number of public keys PK which are in each case allocated to a signature of another person.

In a further advantageous embodiment, at least the characterizing character sequence HED and at least the encrypted biometric features BMUᵥ, BMHᵥ and/or the unencrypted biometric features BMH, BMU are connected to form the signature record SIG and cryptographically digitally signed by means of at least one first secret key S1.

Advantageously, the signature record SIG is additionally cryptographically digitally signed by means of a second secret key S2 independent from the first secret key S1. Independent means that two secret keys S1, S2 of two different and mutually independent certification offices are used. In this case, a signature record SIG is only considered to be valid if the connection between the document DOC or the detected character sequence SBH copied in handwriting with its biometric features BMH is acknowledged by both signatures and both signatures are valid.

Depending on requirements, only particular biometric features BMH of the character sequence SBH copied in handwriting and/or particular biometric features BMU of the handwritten particular signature by name SBU can be encrypted for acceptance into the signature record SIG and in each case other biometric features can be left unencrypted for acceptance in the signature record SIG. Thus, for instance, only the variation of pressure during the signing process could be encrypted and the trace could be left completely unencrypted, in contrast, or, for instance conversely, one of the two components of the trace, i.e., e.g. function t→y(t), could be encrypted and the other two functions t→x(t) and t→d(t) could be left unencrypted.

The signature record SIG advantageously contains also a data of the signature, a detected graphical typeface of the handwritten particular signature by name SBU, a detected graphical typeface of the handwritten characterizing character sequence HED, HES1, HES2 or their short form HEDₖ, HES1ₖ, HES2ₖ respectively and/or the complete name of the signer.

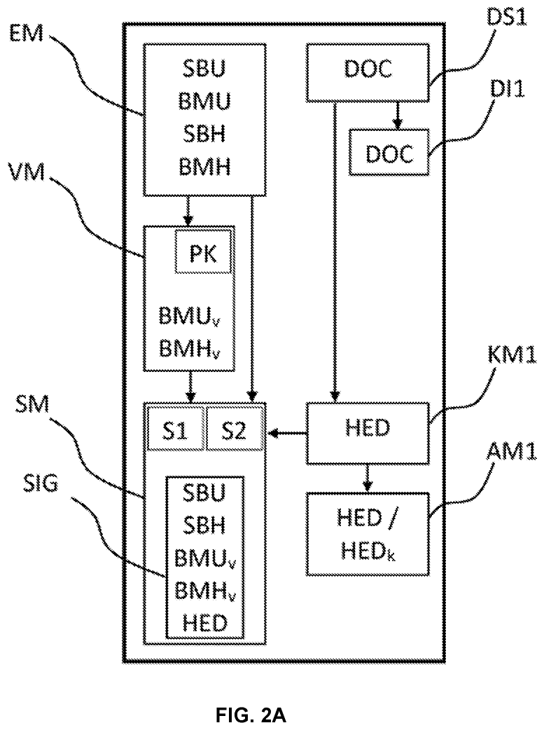

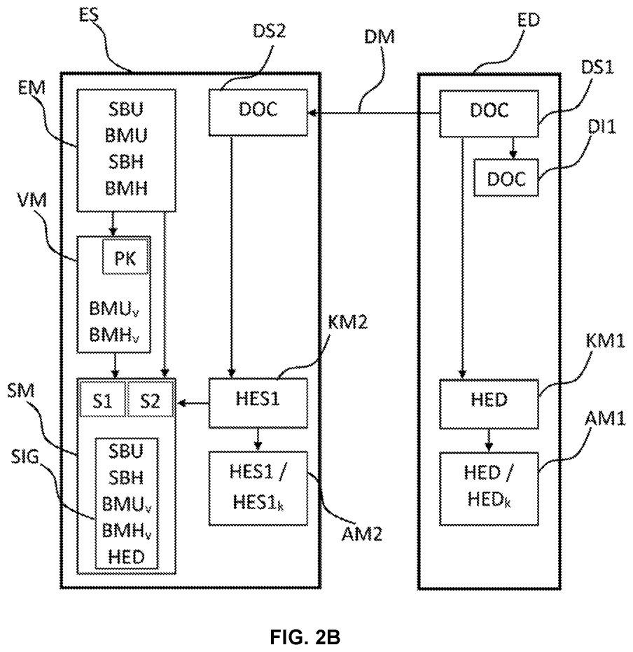

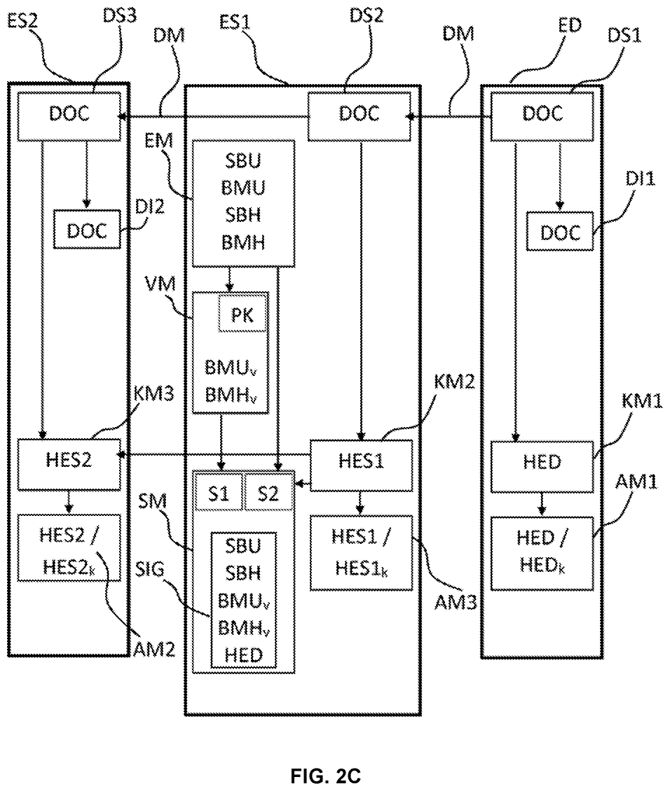

FIG. 2A shows a first embodiment of a signature generating system according to the invention. The signature generating system has a first document memory DS1 in which an electronic document DOC can be stored. The electronic document DOC can be configured, for example, in a conventional form as PDF or WORD document or also have an arbitrary different digital format such as, for instance, a ZIP file, possibly comprising a number of part-documents. The electronic document DOC can either be generated by the signature generating system itself or transmitted into the signature generating system.

In addition, the signature generating system has a first display means D11, by means of which the electronic document DOC can be displayed. The first display means DI1 can be designed, in particular, as a conventional LCD display or the like with or without touch-sensitive function, or also as a printer.

According to the invention, the signature generating system has a first electronic characterizing means KM1 and a first output means AM1 electronically connected to the first characterizing means KM1. The first characterizing means KM1 generates from data of the electronic document DOC in the first document memory DS1 a first character sequence HED characterizing the electronic document DOC according to the method described above. The first output means AM1 outputs the first characterizing character sequence HED, and/or particularly the short form HEDₖ based thereon, visually or acoustically. The first output means AM1 can advantageously use the first display means DI1 for outputting so that the document DOC and the first characterizing character sequence HED and/or their short form HEDₖ are jointly output on the first display means D11.

In addition, the signature generating system has an electronic detection means EM which electronically detects the character sequence SBH copied in handwriting, together with at least one biometric feature BMH characterizing the character sequence SBH copied in handwriting. The detection means EM preferably also detects the particular signature by name SBU and a biometric feature BMU characterizing the particular signature by name SBU. The detection means EM can in particular be designed as a signature pad or touchscreen.

Furthermore, the signature generating system has an electronic signature means SM which generates an electronic signature record SIG at least based on a characterizing character sequence HED, HES1, HES2 and at least one biometric feature BMH characterizing the character sequence SBH copied in handwriting.

In particular, the signature generating system has an electronic encryption means VM which encrypts at least one biometric feature BMH of the character sequence SBH copied in handwriting with a public key PK of an asymmetric pair of keys cryptographically to form an encrypted biometric feature BMHᵥ.

Advantageously, the public key PK used by the encryption means VM is configurable. This means that it is exchangeable and can be exchanged by another key. In particular, a number of public keys PK are stored in the unit ED, ES, ES1. In this context, the public key PK to be used for the encryption can be selected by the user of the unit ES, ED, ES1.

The electronic signature means SM preferably connects at least the characterizing character sequence HED to encrypted biometric features BMUᵥ, BMHᵥ and/or unencrypted biometric features BMH, BMU to form a signature record SIG and signs it cryptographically digitally with at least one, preferably with two secret keys S1, S2 of in each case an asymmetric pair of keys.

FIG. 2B shows a second embodiment of a signature generating system according to the invention. In contrast to the first embodiment, the signature generating system is divided into two units ED, ES physically separated from one another. Physically separated means in this context that the units can be operated as mutually independent and self-contained electronic devices which can only exchange data controlled by means of data transmission means.

In this context, the first unit ED has the first document memory DS1, the first characterizing means KM1 and the first output means AM1 which have the same function as in the first embodiment.

The second unit ES designed to be physically separate from the first unit ED has a second document memory DS2, a second characterizing means KM2, a second output means AM2 connected electronically to the second characterizing means KM2 and the detection means EM which also has the same function as in the first embodiment.

The first unit ED and the second unit ES have in each case an electronic data transmission means DM. The data transmission means DM electronically transmit the electronic document DOC from the first document memory DS1 of the first unit ED into the second document memory DS2 of the second unit ES. The data transmission means DM is preferably based on a cableless data transmission, particularly on Bluetooth, NFC or 802.11-WLAN technology.

The second characterizing means KM2 generates from data of the electronic document DOC in the second document memory DS2 a second character sequence HES1 characterizing the electronic document DOC according to the method described above. As long as the document DOC in the first document memory DS1 and in the second document memory DS2 are identical, the characterizing character sequence HED and the second characterizing character sequence HES1 must be identical. The second output means AM2 outputs the second characterizing character sequence HES1 and/or its short form HES1ₖ visually or acoustically so that the two characterizing character sequences HED, HES1 or the two short forms HEDₖ, HES1ₖ can be compared with one another. This makes it possible to ensure that the document DOC has not been manipulated.

Preferably, the second unit ES has the encryption means VM and particularly the signature means SM which have the same functions as in the first embodiment.

FIG. 2C shows a third embodiment of a signature generating system according to the invention. In distinction from the second embodiment, the second unit ES is divided into two part-units ES1 and ES2 separated from one another physically. The first part-unit ES1 and the second part-unit ES2 have in each case electronic data transmission means DM.

The first part-unit ES1 has the second document memory DS2, the second characterizing means KM2 and the detection means EM, the functions of which corresponding to the second embodiment.

The second part-unit ES2 has a third document memory DS3 a third characterizing means KM3 and the second output means AM2.

The data transmission means DM electronically transmits the electronic document DOC from the second document memory DS2 of the first part-unit ES1 into the third document memory DS3 of the second part-unit ES2.

The third characterizing means KM3 of the second part-unit ES2 generates from data of the electronic document DOC in the third document memory DS3 a third character sequence HES2 characterizing the electronic document DOC according to the method described above. The second output means AM2 of the second part-unit ES2 outputs the third characterizing character sequence HES2 and/or its short form HES2_{K} visually or acoustically.

The data transmission means DM transmit the electronic document DOC from the first unit ED to the second part-unit ES2 via the interposed first part-unit ES1. The first part-unit ES1 is preferably designed with respect to the transmission and storage technology in such a manner that exactly one electronic document DOC can be stored and transmitted by it with each signature event. This complicates manipulation or exchange of the document DOC during or after the transmission.

In a preferred embodiment, the second characterizing character sequence HES1 is transmitted by means of the data transmission means DM from the first part-unit ES1 to the second part-unit ES2. The characterizing means KM3 of the second part-unit ES2 has means for comparing the second and third characterizing character sequences HES1, HES2 or their short forms HES1ₖ, HES2ₖ and indicates an identity or a difference via the output means AM2. As an alternative, the first part-unit ES1 has a third output means, not shown, by means of which the second characterizing character sequence HES1 or its short forms HES1ₖ are output. The second and third characterizing character sequences HES1, HES2 or their short forms HES1ₖ, HES2ₖ respectively, can then be compared visually. This makes it possible to ensure that a document DOC has not been manipulated.

The second unit ES or the first part-unit ES1 of the second unit ES, are preferably designed in the form of a stylus for use in handwriting. The output means AM2 is preferably designed as electronic display for displaying the second characterizing character sequence HES1 or its short form HES1ₖ, respectively, and arranged in the shaft of the stylus. The stylus is advantageously designed for writing on paper, particularly by means of an ink refill or pen/ink cartridge or the like. The stylus has, in particular, pressure sensors or motion sensors by means of which it detects the biometric features BMU, BMS. In an advantageous embodiment of the stylus, the stylus has a fingerprint sensor by means of which it detects the fingerprint when writing with the stylus as an additional biometric feature. In the further embodiment, not shown, the stylus is configured for writing on a pressure-sensitive sensor surface, e.g. that of a smartphone, of a tablet or of a signature pad. In particular, in the case of a signature pad, this provides the possibility of carrying out the detection simultaneously by two different detection means, that of the signature pad and that of the stylus.

Advantageously, an electronic typeface is generated in the signature generating system from the detected biometric features BMU of the handwritten signature. After the detection process of the handwritten signature, the electronic typeface is displayed on at least one of the output means AM1, AM2 or display means D11, DI2 and/or transferred to the first unit ED or second part-unit ES2. Thus, the detected biometric features can be checked for consistency.

The first part-unit ES1 preferably has the encryption means VM and particularly the signature means SM which have the same functions as in the second embodiment. Alternatively, the second part-unit ES2 can also have the encryption means VM and particularly the signature means SM, the detected biometric features BMU, BMH and the character sequence SBH copied in handwritten and the particular signature by name SBU being transferred from the first part-unit ES1 to the second part-unit ES2 by means of the data transmission means DM.

In further advantageous embodiments of the second and third embodiments, the second unit ES and the part-unit ES1 transfer immediately after transmission of the document DOC into an operating mode shielded from the respective electronic environment, wherein the second characterizing character sequence HES1 is generated and represented only in the shielded operating mode. In this context, shielded mode means, in particular, that the data transmission means DM are switched off and any other electronic access to the second unit ES or the part-unit ES1 is stopped.

The signature record SIG generated by the signature means SM and signed digitally can be transferred by means of the data transmission means DM to the first unit ED or to an external unit for archiving or use with the document DOC.

The first unit ED, the second unit ES and the part-units ES1, ES2 are designed as independent electronic devices and, in particular, have a microprocessor or microcontroller by means of which the characterizing means KM1, KM2, KM3, the transmission means DM, the output means AM1, AM2 and the detection means EM are carried out or controlled, respectively. In particular, the characterizing means KM1, KM2, KM3 can be designed as a separate integrated circuit or as program in a separate microcontroller and preferably as a Secure Enclave Processor (SEP). In particular, the secret keys S1, S2 are preferably protected against unauthorized accesses by a Secure Enclave Processor (SEP).

While the above description constitutes the preferred embodiment of the present invention, it will be appreciated that the invention is susceptible to modification, variation and change without departing from the proper scope and fair meaning of the accompanying claims.

1. Method for the electronic signature of an electronic document (DOC) by means of a handwritten signature, wherein detection means (EM) electronically detect the handwritten signature and at least one biometric feature characterizing the handwritten signature,
characterized in that
a characterizing means (KM1, KM2, KM3) generates a character sequence (HED, HES1, HES2), characterizing the electronic document (DOC) and an output means (AM1, AM2) exposes the characterizing character sequence (HED, HES1, HES2) for the signer for handwritten copying and the detection means (EM) electronically detects a character sequence (SBH) copied in handwriting and at least one biometric feature (BMH) characterizing the character sequence (SBH) copied in handwriting, and an electronic signature means (SM) generates an electronic signature record (SIG) at least based on the characterizing character sequence (HED, HES1, HES2) and at least one biometric feature (BMH) characterizing the character sequence (SBH) copied in handwriting.

2. Method according to claim 1,
characterized in that
the characterizing means (KM1, KM2, KM3) calculates the characterizing character sequence (HED, HES1, HES2) as a hash value (H) of the electronic document (DOC) in a representation in which the values of a bit sequence of the hash value (H) are coded by at least two characters of a character set (ZS) and the character set (ZS) is selected in such a manner that the number of its characters is greater than or less than a power of 2.

3. Method according to claim 1 or 2,
characterized in that
the characterizing means (KM1, KM2, KM3), for generating the characterizing character sequence (HED, HES1, HES2), calculates a hash value (H) from data of the electronic document (DOC) and subsequently converts the characters of the hash value (H) into a character representation which is based on a character set (ZS) which comprises more than sixteen characters.

4. Method according to claim 2 or 3,
characterized in that
the characterizing means (KM1, KM2, KM3) in each case converts values of an 8-bit sequence or a 16-bit sequence of the hash value (H) into a supercharacter as a pair of characters or into a supercharacter as a character quadruple of the character set (ZS).

5. Method according to claim 4,
characterized in that
the output means (AM1, AM2) exposes a part of the characters of the characterizing character sequence (HED, HES1, HES2), in particular the first sixteen or the first twenty-four characters as a short form (HEDₖ, HES1ₖ, HES2ₖ) for the characterizing character sequence (HED, HES1, HES2) for the signer for handwritten copying.

6. Method according to claim 5,
characterized in that
the characterizing means (KM1, KM2, KM3) converts the characterizing character sequence (HED) further by means of a permutation of the characters so that the occurrence of a character at a place in the short form (HEDₖ, HES1ₖ, HES2ₖ) of the characterizing character sequence (HED, HES1, HES2) is in each case independent at least of its immediately adjacent characters of the short form (HEDₖ, HES1ₖ, HES2ₖ).

7. Method according to one of claims 2 to 6,
characterized in that
the output means (AM1, AM2) combines at least four, particular six of the in each case successive characters to form in each case a composite word of the characterizing character sequence (HED, HES1, HES2).

8. Method according to one of claims 1 to 7,
characterized in that
the characterizing means (KM1, KM2, KM3) for generating the supercharacters of the characterizing character sequence (HED, HES1, HES2), uses a character set which consists of twenty-six small letters of the modern Latin alphabet.

9. Method according to claim 8,
characterized in that
the output means (AM1, AM2) converts the first character of a composite word of the short form (HEDₖ, HES1ₖ, HES2ₖ) of the characterizing character sequence (HED, HES1, HES2) into the capital letter corresponding to the small letter.

10. Signature generating system for applying the method according to one of claims 1 to 9, having at least one first document memory (DS1) in which an electronic document (DOC) can be stored, at least one first display means (DI1) by means of which the electronic document (DOC) can be displayed, and at least one electronic detection means (EM) by means of which a handwritten signature can be electronically detected together with at least one biometric feature characterizing the handwritten signature,
characterized in that
at least one first electronic characterizing means (KM1) generates from data of the electronic document (DOC) in the first document memory (DS1) a first character sequence (HED) characterizing the electronic document (DOC), in accordance with the method according to one of claims 1 to 9 and at least one first output means (AM1) electronically connected to the first characterizing means (KM1) outputs the first characterizing character sequence (HED) visually or acoustically,
and the detection means (EM) electronically detects at least the character sequence (SBH) copied in handwriting, together with at least one biometric feature (BMH) characterizing the character sequence (SBH) copied in handwriting,
and an electronic signature means (SM) creates an electronic signature record (SIG) at least based on the characterizing character sequence (HED, HES1, HES2) and at least one biometric feature (BMH) characterizing the character sequence (SBH) copied in handwriting.

11. Signature generating system according to claim 10,
characterized in that
a first unit (ED) has the first document memory (DS1), the first characterizing means (KM1) and the first output means (AM1) and a second unit (ES) designed to be physically separate from the first unit (ED) has at least one second document memory (DS2), at least one second characterizing means (KM2) and the detection means (EM),
and the first unit (ED) and the second unit (ES) have in each case at least one electronic data transmission means (DM) and the data transmission means (DM) electronically transmits the electronic document (DOC) from the first document memory (DS1) of the first unit (ED) into the second document memory (DS2) of the second unit (ES), and the second characterizing means (KM2) generates from data of the electronic document (DOC) in the second document memory (DS2) a second character sequence (HES1) characterizing the electronic document (DOC) according to the method according to one of claims 1 to 9.

12. Signature generating system according to claim 11,
characterized in that
the second unit (ES) has a first part-unit (ES1) and a second part-unit (ES2) physically separated from it and the first part-unit (ES1) and the second part-unit (ES2) have in each case electronic data transmission means (DM),
and the first part-unit (ES1) has the second document memory (DS2), the second characterizing means (KM2) and the detection means (EM), and the second part-unit (ES2) has a third document memory (DS3), a third characterizing means (KM3) and the second output means (AM2),
and the data transmission means (DM) electronically transmits the electronic document (DOC) from the second document memory (DS2) of the first part-unit (ES1) into the third document memory (DS3) of the second part-unit (ES2) and the third characterizing means (KM3) generates from data of the electronic document (DOC) in the third document memory (DS3) a third character sequence (HES2) characterizing the electronic document (DOC) according to the method according to one of claims 1 to 9 and the second output means (AM2) outputs the third characterizing character sequence (HES2) visually or acoustically.

13. Signature generating system according to claim 11 or 12,
characterized in that
the data transmission means (DM) transmits the electronic document (DOC) from the first unit (ED) to the second unit (ES) or via the interposed first part-unit (ES1) to the second part-unit (ES2), wherein the second unit (ES) or the first part-unit (ES1), respectively, is designed with respect to the transmission and storage technology in such a manner that only exactly one electronic document (DOC) can be stored and transmitted by it with each signature event.

14. Signature generating system according to one of claims 10 to 13,
characterized in that
the output means (AM1, AM2) exposes a part of the characters of the characterizing character sequence (HED, HES1, HES2), particularly the first sixteen or the first twenty-four characters as short form (HEDₖ, HES1ₖ, HES2ₖ) of the characterizing character sequence (HED, HES1, HES2) visually or acoustically for the signer for handwritten copying.

15. Signature generating system according to one of claims 10 to 14,
characterized by
an electronic encryption means (VM) which encrypts at least one biometric feature (BMH) of the character sequence (SBH) copied in handwriting with a public key (PK) of an asymmetric pair of keys cryptographically to form an encrypted biometric feature (BMHᵥ) and the public key (PK) used by the encryption means (VM) is configurable and, in particular, a number of public keys (PK) are stored in the unit (ED, ES, ES1) and the public key (PK) to be used for the encryption is selectable by the user of the unit (ES, ED, ES1) for a signature event.

16. Signature generating system according to one of claims 11 to 15,
characterized in that
the second unit (ES) or the first part-unit (ES1) of the second unit (ES) is designed in the form of a stylus for use for handwritten writing and the detection means (EM) have motion sensors, pressure sensors and/or fingerprint sensors for the electronic detection of the biometric features (BMU, BMH).

17. Signature generating system according to one of claims 11 to 16,
characterized in that
the second unit (ES) or the first part-unit (ES1) enter immediately after transmission of the document (DOC) into an operating mode shielded from the respective electronic environment and the character sequence (HED, HES1, HES2) characterizing the electronic document (DOC) is generated and displayed only in the shielded operating mode.

18. Unit for a signature generating system according to one of claims 10 to 17,
characterized by
the features of the first unit (ED) or the second unit (ES) or the first part-unit (ES1) according to one of claims 10 to 17.
